(19) United States
(12) Patent Application Publication
(10) Pub. No.: US 2009/0254652 A1
(43) Pub. Date: Oct. 8, 2009

(54) RESOURCE CORRELATION PREDICTION

(75) Inventors: Kevin M. Binswanger, Atlanta, GA (US); Christopher C. Ting, La Palma, CA (US); Lifeng Zhang, Rockville, MD (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/098,799

(22) Filed: Apr. 7, 2008

(51) Int. Cl. G06F 15/16

(52) U.S. Cl. 709/224

(57) ABSTRACT

Embodiments of the present invention address deficiencies of the art in respect to resource mapping in a change configuration and systems monitoring solution and provide a novel and non-obvious method, system and computer program product for predictively mapping automatically discovered resources in a monitored system with a manually specified resource for the monitored system. In an embodiment of the invention, a resource mapping method for application dependency and discovery can be provided. The method can include automatically discovering resources in a monitored system, manually specifying a resource in the monitored system, filtering the automatically discovered resources to a set of resources likely to match the manually specified resource, and mapping the manually specified resource to a resource in the filtered set of resources.

### BACKGROUND OF THE INVENTION

1. Field of the Invention

The present invention relates to the field of enterprise computing and network administration, and more particularly to the operation and management of a configuration management database (CMDB).

2. Description of the Related Art

The task of modern network administration differs significantly from that of days gone by. Not just a decade ago, network administration primarily entailed the addition and deletion of network users, the management of print queues, and the supervision and operation of daily backup procedures. Most if not all resources required by network applications remained present in the network itself, and few if any network applications depended upon the operation of other, co-executing applications.

Much has changed since the early days of network computing. Today, enterprise computing permeates the electronic landscape. While some enterprise applications remain largely stand-alone, most rely in some respect on a co-existing enterprise application or a soft enterprise resource, such as a database application, Web application server, or other cooperating component. Thus, the administration of the network has advanced far beyond user and print queue administration and daily backup routines. Today, the inter-dependencies among network components present a significant challenge to the network administrator. In this regard, the management of a single network component can depend upon the state of a multiplicity of other network components.

Changing components or configuration settings with a network architecture requires careful consideration of the potential impact of a given change. System changes generally are known to be the source of architectural missteps in even the simplest of network structures. As system complexity increases, however, the number of errors caused by a configuration change increases exponentially. The advent of the configuration management database (CMDB) acts to remediate the foregoing problem and creates an opportunity to help identify and prevent potential errors.

A CMDB is a unified or federated repository of information related to all the components of an information system. A CMDB provides a view to the information technology manager of an organization in order to understand the relationships between the components of the information system. The CMDB further facilitates the monitoring and management of the configuration of the components of the information system. The CMDB can be populated both with automatically discovered resources, as well as manually specified resources.

Notably, advanced forms of change configuration and systems monitoring solutions perform automated discovery of resources to compliment the manual entry of known resources. Oftentimes, however, duplicate entries of resources can arise where the end user manually specifies a resource coincidentally automatically discovered. As such, change configuration and systems monitoring solutions providing a two-pane mapping interface through which manually specified resources can be mapped manually to automatically discovered resources. To the extent that the list of automatically discovered resources is extensive, however, it can be difficult to readily identify duplicate entries.

### BRIEF SUMMARY OF THE INVENTION

Embodiments of the present invention address deficiencies of the art in respect to resource mapping in a change configuration and systems monitoring solution and provide a novel and non-obvious method, system and computer program product for predictively mapping automatically discovered resources in a monitored system with a manually specified resource for the monitored system. In an embodiment of the invention, a resource mapping method for application dependency and discovery can be provided. The method can include automatically discovering resources in a monitored system, manually specifying a resource in the monitored system, filtering the automatically discovered resources to a set of resources likely to match the manually specified resource, and mapping the manually specified resource to a resource in the filtered set of resources.

In another embodiment of the invention, an application dependency and discovery data processing system can be provided. The system can include a CMDB, an application dependency and discovery server coupled to the CMDB, a discovery engine coupled to the application dependency and discovery server and configured to automatically discover resources in a communicatively linked monitored system, and predictive resource mapping logic coupled to the discovery engine. The logic can include program code enabled to filter the automatically discovered resources to a set of resources likely to match a manually specified resource, to map the manually specified resource to a resource in the filtered set of resources, and to store the mapping in the CMDB.

In one aspect of the embodiment, the program code of the predictive resource mapping logic can include program code enabled to filter the automatically discovered resources to a set of resources correlating to a manually specified resource according to criteria selected from the group consisting of a similar set of respective system lists, product information, resource names and resource tags. In another aspect of the embodiment, the system can include a two-pane view rendered by the predictive resource mapping logic. The view can include one pane presenting the manually specified resource and a second pane presenting the filtered set of resources.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for predictively mapping automatically discovered resources in a monitored system with a manually specified resource for the monitored system;

FIG. 2 is a schematic illustration of a change configuration management and systems monitoring data processing system configured to predictively map automatically discovered resources in a monitored system with a manually specified resource for the monitored system; and,

FIG. 3 is a flow chart illustrating a process for predictively mapping automatically discovered resources in a monitored system with a manually specified resource for the monitored system.

### DETAILED DESCRIPTION OF THE INVENTION

Embodiments of the present invention provide a method, system and computer program product for predictively mapping automatically discovered resources in a monitored system with a manually specified resource for the monitored system. In accordance with an embodiment of the present invention, an individual manually specified resource can be presented in one pane of a two-pane user interface while a list of automatically discovered resources can be presented in the second pane of the two-pane user interface. The list of automatically discovered resources can be filtered, however, according to a likelihood that a given one of the automatically discovered resources is likely to correlate to the manually specified resource. Criteria for the correlation can include the sharing of similar system lists, product information, names and tags.

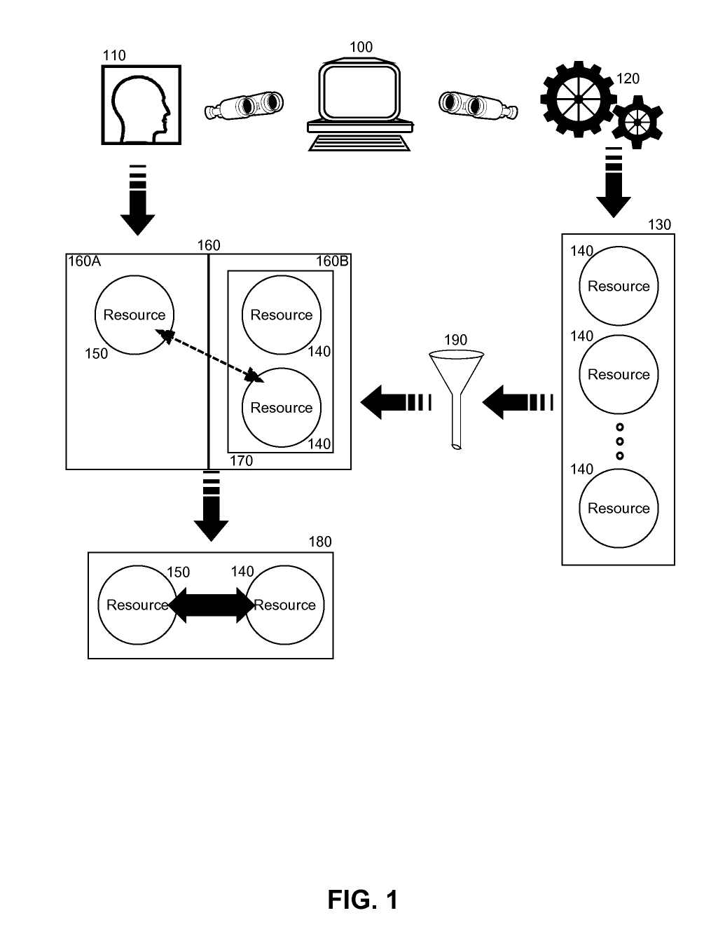

In further illustration, FIG. 1 is a pictorial illustration of a process for predictively mapping automatically discovered resources in a monitored system with a manually specified resource for the monitored system. As shown in FIG. 1, a monitored system 100 can be observed by both an end user 110 and an automated monitoring system 120. The automated monitoring system 120 can automatically discover a full set 130 of resources 140 in the monitored system 100. Likewise, the end user 110 can manually specify a resource 150 in the monitored system 100. As it will be recognized by one skilled in the art, the manually specified resource 150 can overlap one of the automatically discovered resources 140 in the full set 130.

To that end, a two-pane view 160 can be provided to match the manually specified resource 150 in a first pane 160A with a corresponding one of the automatically discovered resources 140 in a filtered set 170 of the automatically discovered resources 140 in a second pane 160B. Specifically, to facilitate the matching, a filtered set 170 of the automatically discovered resources 140 can be generated with a filter 190 from the full set 130 according to the resources 140 in the full set 130 most likely to be matched to the manually specified resource 150. Those of the resources 140 in the full set 130 most likely to be matched to the manually specified resource 150 can be predicted by the filter 190 according to similar system lists, product information, names or tags. Thereafter, the matched manually specified resource 150 and automatically discovered resource 140 can be stored in a mapping 180 for the automated monitoring system 120.

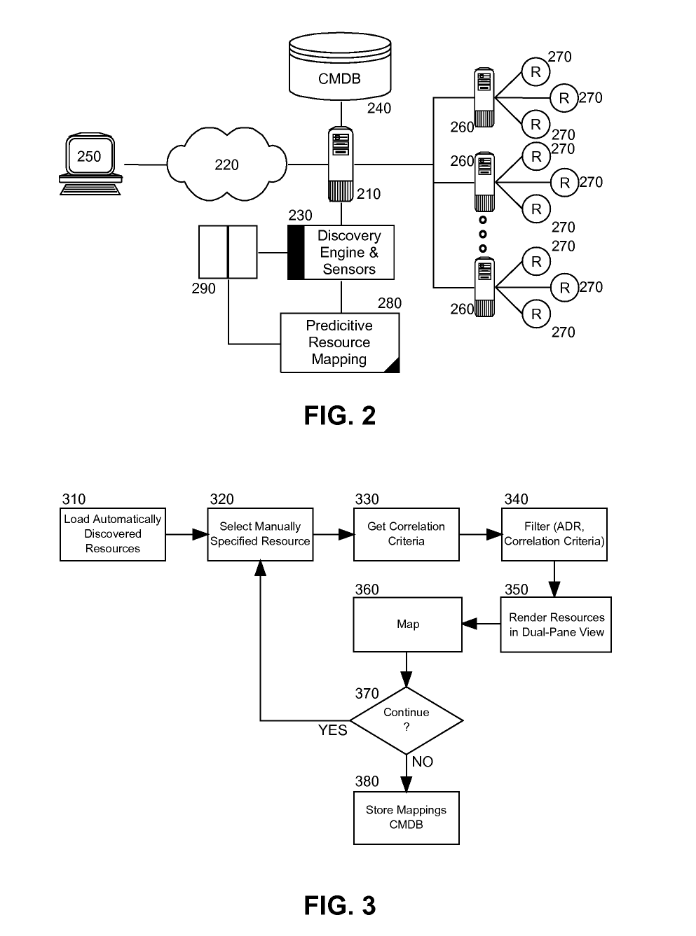

In further illustration, FIG. 2 is a schematic illustration of a change configuration management and systems monitoring data processing system configured to predictively map automatically discovered resources in a monitored system with a manually specified resource for the monitored system. The system can include an application dependency and discovery server 210 configured for communicative coupling to an accessor client 250 over computer communications network 220. The application dependency and discovery server 210 can be coupled both to a CMDB 240 and a discovery engine 230.

The application dependency and discovery server 210 also can be communicatively linked to one or more different information technology (IT) infrastructure components 260, each providing one or more IT resources 270 (either hardware resources, software resources or both). In this regard, the discovery engine 230 can be configured to perform automated discovery of one or more of the IT resources 270 and to populate the CMDB 240 accordingly. Additionally, the discovery engine 230 can be configured to accept a manual specification of any of the IT resources 270 for inclusion in the CMDB 240.

Notably, predictive resource mapping logic 280 can be coupled to the discovery engine 230 and to a two-pane view 290 provided as an interface to the discovery engine 230. The predictive resource mapping logic 280 can include program code enabled to filter automatically discovered ones of the resources 270 according to a likelihood that a given one of the resources 270 is likely to match to a manually specified one of the resources 270. In this regard, automatically discovered ones of the resources 270 can correlate to a manually specified one of the resources 270 based upon similar system lists, e.g. similar defined sets of managed systems. Also, automatically discovered ones of the resources 270 can correlate to a manually specified one of the resources 270 based upon similar product information, or similar or identical names for the resources 270. Finally, automatically discovered ones of the resources 270 can correlate to a manually specified one of the resources 270 based upon similar tags for the resources 270 including same or similar key-value pairs for tags for the resources 270.

Upon operation of the predictive resource mapping logic 280, a filtered set of the resources 270 can be presented in one pane of the two-pane view 290, while the corresponding manually specified one of the resources 270 can be presented in the other pane of the two-pane view 290. Consequently, an end user through accessor client 250 can visually match the manually specified one of the resources 270 with a selected one of the filtered one of the resources 270 through the two-pane view 290. Thereafter, the CMDB 240 can be updated with the mapping.

In yet further illustration, FIG. 3 is a flow chart illustrating a process for predictively mapping automatically discovered resources in a monitored system with a manually specified resource for the monitored system. Beginning in block 310, automatically discovered resources in a monitored system can be loaded and in block 320, a manually specified resource can be selected for mapping. In block 330, one or more correlation criteria can be retrieved for application to the automatically discovered resources. The correlation criteria can include, for example, similar system lists, product information, names and tags between individual ones of the automatically discovered resources and the manually specified resource.

In block 340, the automatically discovered resources can be filtered according to the criteria to produce a filtered set of automatically discovered resources. Thereafter, in block 350 the filtered set of automatically discovered resources can be rendered in one pane of a two-pane view while the manually specified resource can be specified in a second pane of the two-pane view. In block 360, the manually specified resource can be mapped to one of the resources in the filtered set of automatically discovered resources. Finally, in decision block 370, it can be determined whether or not to match another manually specified resource. If not, the process can end in block 380 with a storing of the mapping in the CMDB.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A resource mapping method for application dependency and discovery, the method comprising:
automatically discovering resources in a monitored system;
manually specifying a resource in the monitored system;
filtering the automatically discovered resources to a set of resources likely to match the manually specified resource; and,
mapping the manually specified resource to a resource in the filtered set of resources.

2. The method of claim 1, wherein filtering the automatically discovered resources to a set of resources likely to match the manually specified resource comprises filtering the automatically discovered resources to a set of resources correlating to the manually specified resource according to a similar set of respective system lists.

3. The method of claim 1, wherein filtering the automatically discovered resources to a set of resources likely to match the manually specified resource comprises filtering the automatically discovered resources to a set of resources correlating to the manually specified resource according to a similar set of respective product information.

4. The method of claim 1, wherein filtering the automatically discovered resources to a set of resources likely to match the manually specified resource comprises filtering the automatically discovered resources to a set of resources correlating to the manually specified resource according to a similar set of respective resource names.

5. The method of claim 1, wherein filtering the automatically discovered resources to a set of resources likely to match the manually specified resource comprises filtering the automatically discovered resources to a set of resources correlating to the manually specified resource according to a similar set of respective resource tags.

6. The method of claim 1, wherein mapping the manually specified resource to a resource in the filtered set of resources comprises:
rendering a two-pane view;
presenting the manually specified resource in first pane of the two-pane view;
presenting the filtered set of resources in a second pane of the two-pane view; and,
visually mapping the manually specified resource in the first pane to a resource in the filtered set of resources in the second pane.

7. The method of claim 1, wherein mapping the manually specified resource to a resource in the filtered set of resources further comprises storing the mapping in a configuration management database (CMDB).

8. An application dependency and discovery data processing system comprising:
a configuration management database (CMDB);
an application dependency and discovery server coupled to the CMDB;
a discovery engine coupled to the application dependency and discovery server and configured to automatically discover resources in a communicatively linked monitored system; and,
predictive resource mapping logic coupled to the discovery engine and comprising program code enabled to filter the automatically discovered resources to a set of resources likely to match a manually specified resource, to map the manually specified resource to a resource in the filtered set of resources, and to store the mapping in the CMDB.

9. The system of claim 8, wherein the program code of the predictive resource mapping logic comprises program code enabled to filter the automatically discovered resources to a set of resources correlating to a manually specified resource according to criteria selected from the group consisting of a similar set of respective system lists, product information, resource names and resource tags.

10. The system of claim 8, further comprising a two-pane view rendered by the predictive resource mapping logic, the view comprising one pane presenting the manually specified resource and a second pane presenting the filtered set of resources.

11. A computer program product comprising a computer usable medium embodying computer usable program code for resource mapping for application dependency and discovery, the computer program product comprising:
computer usable program code for automatically discovering resources in a monitored system;
computer usable program code for manually specifying a resource in the monitored system;
computer usable program code for filtering the automatically discovered resources to a set of resources likely to match the manually specified resource; and,
computer usable program code for mapping the manually specified resource to a resource in the filtered set of resources.

12. The computer program product of claim 11, wherein the computer usable program code for filtering the automatically discovered resources to a set of resources likely to match the manually specified resource comprises computer usable program code for filtering the automatically discovered resources to a set of resources correlating to the manually specified resource according to a similar set of respective system lists.

13. The computer program product of claim 11, wherein the computer usable program code for filtering the automatically discovered resources to a set of resources likely to match the manually specified resource comprises computer usable program code for filtering the automatically discovered resources to a set of resources correlating to the manually specified resource according to a similar set of respective product information.

14. The computer program product of claim 11, wherein the computer usable program code for filtering the automatically discovered resources to a set of resources likely to match the manually specified resource comprises computer usable program code for filtering the automatically discovered resources to a set of resources correlating to the manually specified resource according to a similar set of respective resource names.

15. The computer program product of claim 11, wherein the computer usable program code for filtering the automatically discovered resources to a set of resources likely to match the manually specified resource comprises computer usable program code for filtering the automatically discovered resources to a set of resources correlating to the manually specified resource according to a similar set of respective resource tags.

16. The computer program product of claim 11, wherein the computer usable program code for mapping the manually specified resource to a resource in the filtered set of resources comprises:
computer usable program code for rendering a two-pane view;
computer usable program code for presenting the manually specified resource in first pane of the two-pane view;
computer usable program code for presenting the filtered set of resources in a second pane of the two-pane view; and,
computer usable program code for visually mapping the manually specified resource in the first pane to a resource in the filtered set of resources in the second pane.

17. The computer program product of claim 11, wherein the computer usable program code for mapping the manually specified resource to a resource in the filtered set of resources further comprises computer usable program code for storing the mapping in a configuration management database (CMDB).
